(19) United States
(12) Patent Application Publication
(10) Pub. No.: US 2011/0240661 A1
(43) Pub. Date: Oct. 6, 2011

(54) STRUCTURE OF A PLASTIC CONTAINER HAVING A FLANGE, MOULD THEREOF AND METHOD FOR MANUFACTURING THE SAME

(75) Inventor: FRANK KO, Suzhou (CN)

(73) Assignee: Suzhou Kefu Gift Industry Co., LTD., Suzhou (CN)

(21) Appl. No.: 13/052,043

(22) Filed: Mar. 18, 2011

(30) Foreign Application Priority Data
Apr. 6, 2010 (CN) 201010149411.9

(51) Int. Cl. B65D 1/42; B29C 45/03; B29C 45/40; B29C 71/00

(52) U.S. Cl. 220/657; 425/542; 425/556; 264/161

(57) ABSTRACT

A structure of a plastic container having a hollow flange, a mould thereof and a method for manufacturing the same are provided in the present invention. The mould of the plastic container includes a first mould plate and a second plate. The first mould plate has a mould cavity, and the second mould plate has a mould insert. The mould cavity and the mould insert are combined to form a body-forming space and a flange-forming space. The flange-forming space surrounds an end surface of the body-forming space. The mould can feed air into a flange-forming space by an air-supplying pipe and a material-overflowing space during the injection molding of the mould, thereby forming a finished product of the plastic container having a hollow-shaped flange. The structure of the plastic container includes a body and a flange having a closed hollow portion. The plastic container has a better structure strength.

### BACKGROUND OF THE INVENTION

1. Field of the Invention

The present invention relates to a structure of a plastic container having a flange, a mould thereof and a method for manufacturing the same, and more particularly to a structure of a plastic container having a hollow flange, a mould thereof and a method for manufacturing the same by feeding air to assist the injection molding.

2. Description of the Prior Art

An existing plastic container having a flange, such as a flowerpot, is shown in FIG. 1, which discloses a sectional view of a mould of an existing flowerpot. The mould 10 of the flowerpot includes a first mould plate 11 and a second mould plate 12. The first mould plate 11 defines a mould cavity 11a. The second mould plate 12 disposes a mould insert 12a corresponding to the mould cavity 11a. After the first mould plate 11 and the second mould plate 12 are closed, the mould cavity 11a of the first mould plate 11 and the mould insert 12a of the second mould plate 12 commonly define a body-forming space 13. The body-forming space 13 is corresponding to a pot body of the flowerpot. There also has an opened flange-forming space 14, which is arranged to encompass the edge of an opening of the body-forming space 13 (namely the pot body of the flowerpot). The flange-forming space 14 is corresponding to a flange of the edge of the flowerpot. Moreover, the mould also has a plastic-injecting pipe 15 disposed on an outside end of the first mould plate 11. The plastic-injecting pipe 15 is communicated with an exterior plastic-injecting system 16 and a location (such as a bottom of the flowerpot) of the body-forming space 13.

Please refer to FIG. 2, which discloses a sectional view of a state injecting a plastic material into the mould of the prior flowerpot. The plastic-injecting system 16 can inject a liquid plastic P1, which is heated to be liquid, into the body-forming space 13 and the flange-forming space 14 through the plastic-injecting pipe 15.

Please refer to FIG. 3, which discloses a sectional view of a state taking out a finished product after formed in the mould of the flowerpot. After being injected into the body-forming space 13 and the flange-forming space 14, the liquid plastic P1 can be cured to form a solid plastic P2 by packing pressure and cooling the mould. Now, the finished product of a flowerpot 20 has been made by separating the first mould plate from the second mould plate, taking out the solid plastic P2, and then removing unwanted stub bars of the solid plastic P2. The flowerpot 20 has an opened flange 21.

However, the flowerpot (such as a bowl-shaped container) has some defects: the structure strength of the opened flange 21 of the flowerpot 20 is limited. When the flowerpot 20 is loaded with the soil and the plant, if the flange 21 is grasped to carry the flowerpot 20, the flange 21 will be generally broken due to not taking the whole weight, at least maybe destroyed, or even maybe hurt the personnel due to the flowerpot 20 falling off.

Please refer to FIGS. 4 and 5, which disclose sectional views of a mould of another flowerpot and a finished product thereof, respectively. The difference between the mould and the finished product of FIGS. 4 and 5 and those of FIGS. 1 to 3 is that: the flowerpot 20 of FIG. 5 has a solid flange 21′. Comparing with the opened flange 21, the solid flange 21′ has a better strength. When the flange 21′ is grasped to carry the flowerpot 20, the flange 21′ may bear the greater weight. However, although the structure of the flange 21′ is firmer, the thickness of the flange 21′ is too greater than the even forming thickness of the flowerpot 20 so that wasting the material. And after the solid plastic P2 being formed by cooling, it is easily resulted in the deformation of a finished product because a shrinkage rate difference caused by the thickness difference is over great.

Hence, it needs to provide a structure of a plastic container having a flange, a mould thereof and a method for manufacturing the same to solve the defects existed in the prior art.

### BRIEF SUMMARY OF THE INVENTION

A primary object of the present invention is to provide a mould of a plastic container having a flange, which can feed air into a flange-forming space by an air-supplying pipe and a material-overflowing space opposite to the air-supplying pipe during the injection molding of the mould, for manufacturing a finished product of the plastic container having a hollow flange, wherein the flange of the finished product of the plastic container and the container body has a uniform thickness and a better structure strength.

A secondary object of the present invention is to provide a structure of a plastic container having a flange, wherein the flange of the plastic container has a hollow portion, a uniform thickness and a better structure strength; the flange can bear the whole weight and not be broken when carrying the plastic container.

To achieve the aforementioned object of the present invention, the present invention provides a mould of a plastic container having a flange, which comprises a first mould plate having a mould cavity, a second mould plate having a mould insert that being combined with the mould cavity to form a body-forming space, a plastic-injecting pipe disposed on the first mould plate or the second mould plate and communicated with an exterior plastic-injecting system and the body-forming space, a flange-forming space surrounding an end surface of the body-forming space, an air-supplying pipe disposing an air-inputting opening on an edge of the flange-forming space and communicated with an exterior air-supplying system and the flange-forming space, and a material-overflowing space disposed on the edge of the flange-forming space, located on another side opposite to the air-supplying pipe, and connected to the flange-forming space through a small hole.

In one embodiment of the present invention, a direction of the air entering into the flange-forming space through the air-supplying pipe is the same with a direction of the liquid plastic entering into the body-forming space through the plastic-injecting pipe.

In one embodiment of the present invention, the material-overflowing space is a spherical shape.

In one embodiment of the present invention, the plastic container having the flange is a flowerpot.

In one embodiment of the present invention, the flange is a round ring shape.

In one embodiment of the present invention, the second mould plate and the mould insert are separated, and an ejection mechanism is employed to detach the finished product from the mould by moving the second mould plate a distance away from the first mould plate after opening the mould.

To achieve the aforementioned object of the present invention, the present invention also provides a structure of a plastic container having a flange. The structure comprises a body being a container having an opening, which forms an upper edge; and a flange forming on the outside of the upper edge and having a closed hollow portion.

In one embodiment of the present invention, the structure of the plastic container further comprises an aperture located on a bottom edge of the flange.

In one embodiment of the present invention, the body and the flange have an equivalent thickness.

To achieve the aforementioned object of the present invention, the present invention also provides a method for manufacturing a structure of a plastic container having a flange.

The manufacturing method comprises the following steps:

Providing a mould; starting to inject a liquid material; continuing to inject the liquid material and starting to feed air; stopping injecting the liquid material and continuing to feed air; stopping feeding air; and taking out a formed solid plastic and modifying it to be a finished product.

Comparing with the prior art, the structure of the plastic container having the flange in the present invention can feed the air into the flange-forming space by the air-supplying pipe and the material-overflowing space, thereby obtaining the finished product of the plastic container having a hollow-shaped flange. The flange of the finished product of the plastic container has the hollow portion. The flange and the body have a uniform thickness and a better structure strength. When carrying the finished product of the container, the flange can bear the whole weight and not be broken.

### BRIEF DESCRIPTION OF THE DRAWINGS

FIG. 1 is a sectional view of a mould of an existing flowerpot;

FIG. 2 is a sectional view of a state injecting a plastic material into the mould of the existing flowerpot;

FIG. 3 is a sectional view of a state taking out a finished product after being formed in the mould of the existing flowerpot;

FIG. 4 is a sectional views of a mould of another flowerpot;

FIG. 5 is a sectional view of a finished product formed by the mould of the another flowerpot;

FIG. 6 is a sectional view of a mould of a plastic container having a flange according to one preferred embodiment of the present invention;

FIG. 7 is a flow chart of a method for manufacturing the plastic container having the flange according to one preferred embodiment of the present invention;

FIGS. 8 to 12 are schematic views of the method for manufacturing the plastic container having the flange according to one preferred embodiment of the present invention; and

FIG. 13 is a perspective sectional view of a structure of the plastic container having the flange according to one preferred embodiment of the present invention.

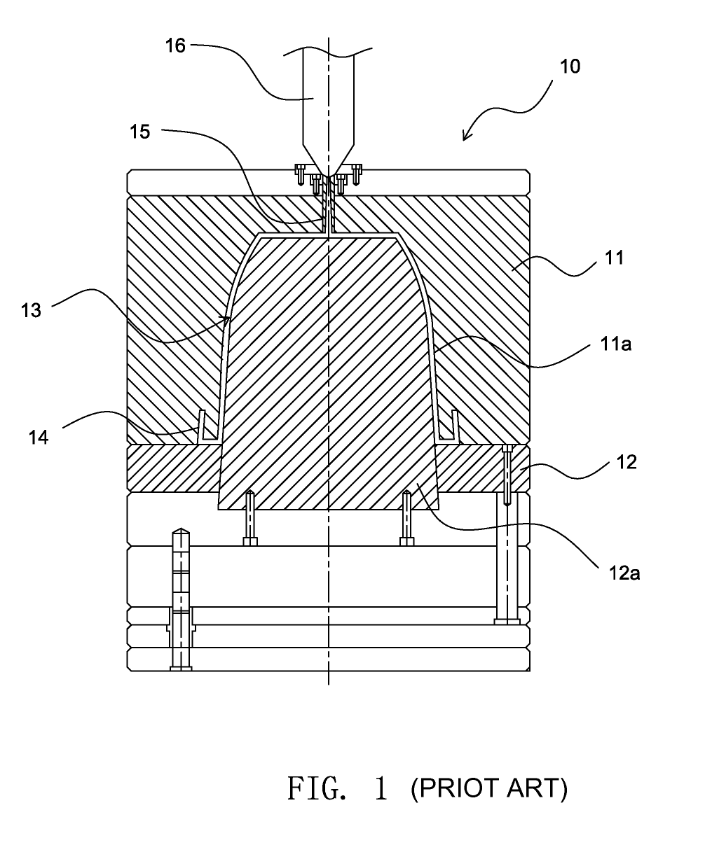

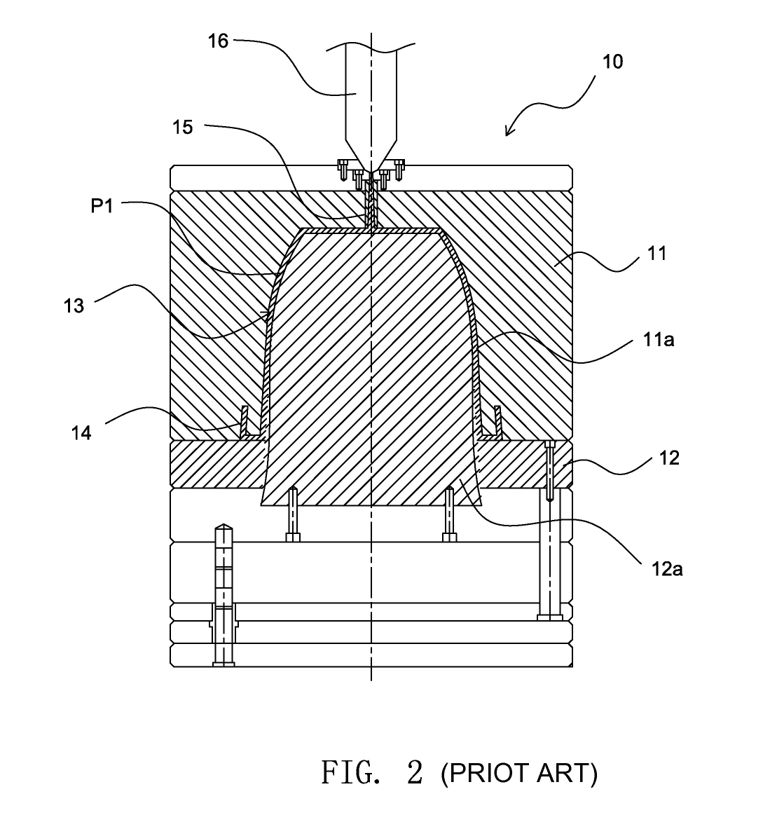

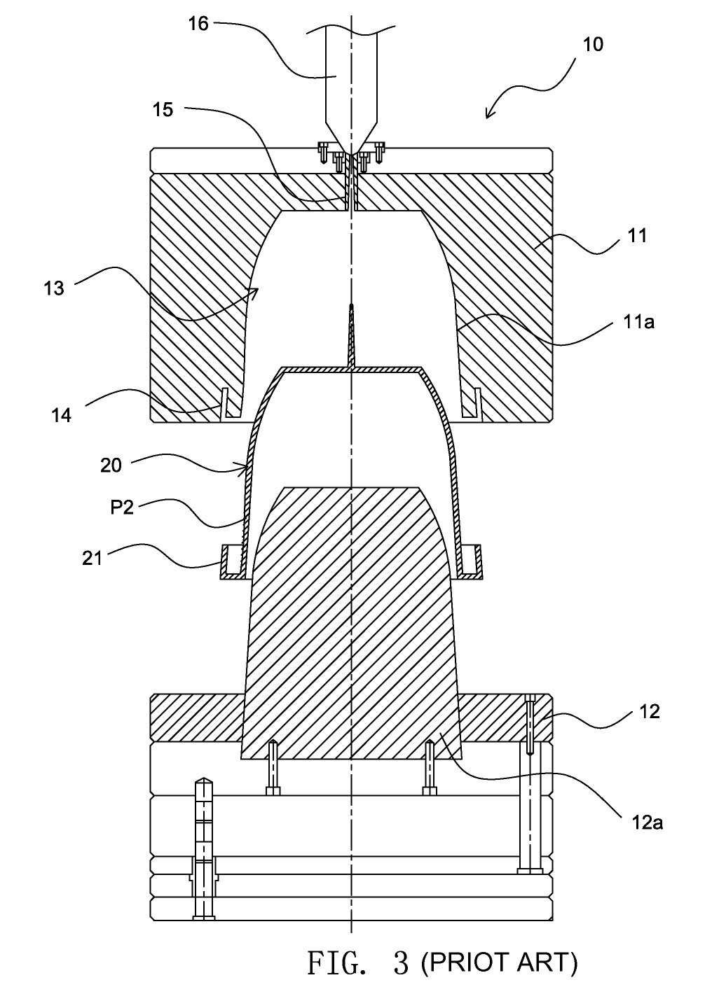

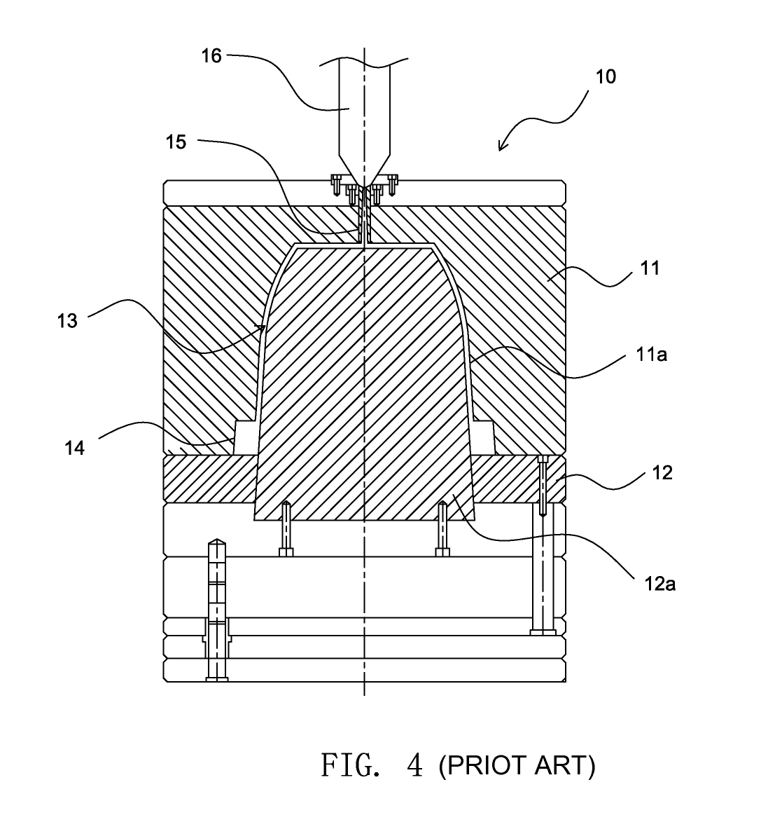

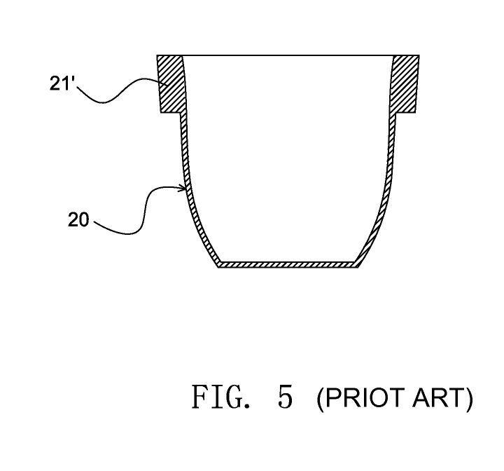

### DETAILED DESCRIPTION OF THE PREFERRED EMBODIMENTS

The present invention will disclose every assembly structure in the following text. And for more clearly and easily understanding the object, the feature and the advantage of the present invention, the following text will take a preferred embodiment of the present invention with reference to the accompanying drawings for detail description as follows.

It needs to be especially explained that a mould of one preferred embodiment of the present invention will take a mould of a flowerpot having a flange as an example, but the present invention cannot be limited to this. A plastic container having a flange mentioned in the present invention also may be a barrel, a box and so on. Moreover, the mould structures mentioned in the present invention are necessary parts of the technical feature thereof, those not mentioned are generally existing structures, not being repeated herein.

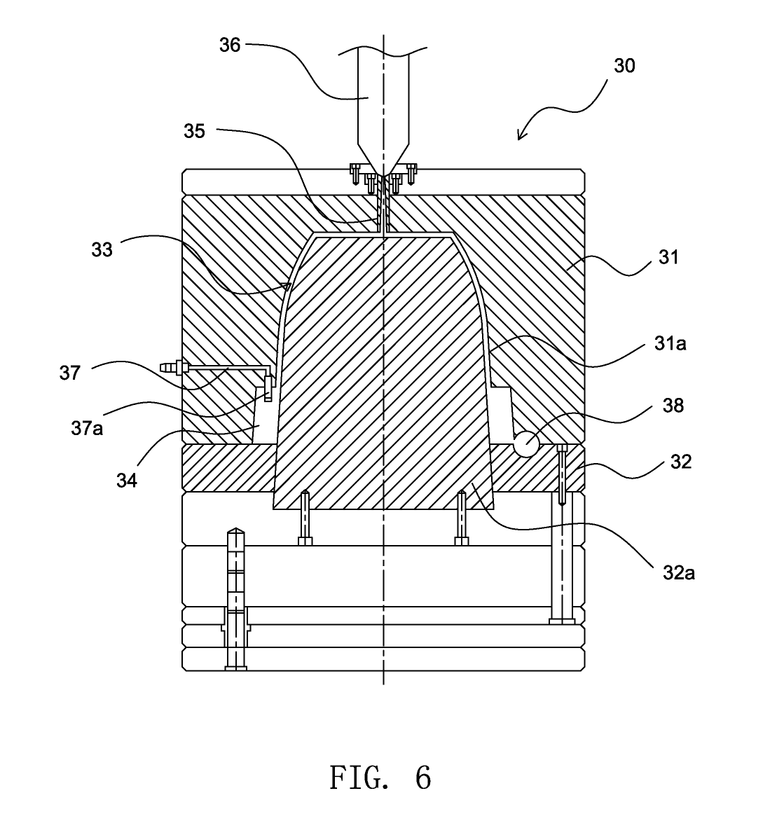

Please refer to FIG. 6, which discloses a sectional view of a mould of a plastic container having a flange according to one preferred embodiment of the present invention. The mould 30 of the plastic container (as a flowerpot) having the flange comprises a first mould plate 31 and a second mould plate 32. The first mould plate 31 disposes a mould cavity 31a. The second mould plate 32 disposes a mould insert 32a corresponding to the mould cavity 31a of the first mould plate 31. After the first mould plate 31 and the second mould plate 32 being closed, the mould cavity 31a of the first mould plate 31 and the mould insert 32a of the second mould plate 32 commonly define a body-forming space 33. The body-forming space 33 is corresponding to a pot body of the flowerpot. There also has an opened flange-forming space 34, which is arranged to encompass an edge of an opening of the body-forming space 33 (namely the pot body of the flowerpot). The flange-forming space 34 is corresponding to the flange on an edge of the flowerpot. Moreover, the mould 30 also has a plastic-injecting pipe 35 disposed on an outside end of the first mould plate 31. The plastic-injecting pipe 35 is communicated with an exterior plastic-injecting system 36 and a location (such as a bottom of the flowerpot) of the body-forming space 33.

Please refer to FIG. 6, in one preferred embodiment of the present invention, the mould 30 of the plastic container having the flange comprises an air-supplying pipe 37 and a material-overflowing space 38. The air-supplying pipe 37 disposes an air-inputting opening 37a, which connects an exterior air-supplying system (not shown in all FIGS) to the flange-forming space 34, on the edge of the flange-forming space 34. The material-overflowing space 38 is located on the edge of the flange-forming space 34, and is a small mould cavity commonly defined by the first mould plate 31 and the second mould plate 32 and receiving the overflowing material. Preferably, the material-overflowing space 38 is located on another side opposite to the air-inputting opening 37a, and is connected to the flange-forming space 34 through a small hole (not labeled).

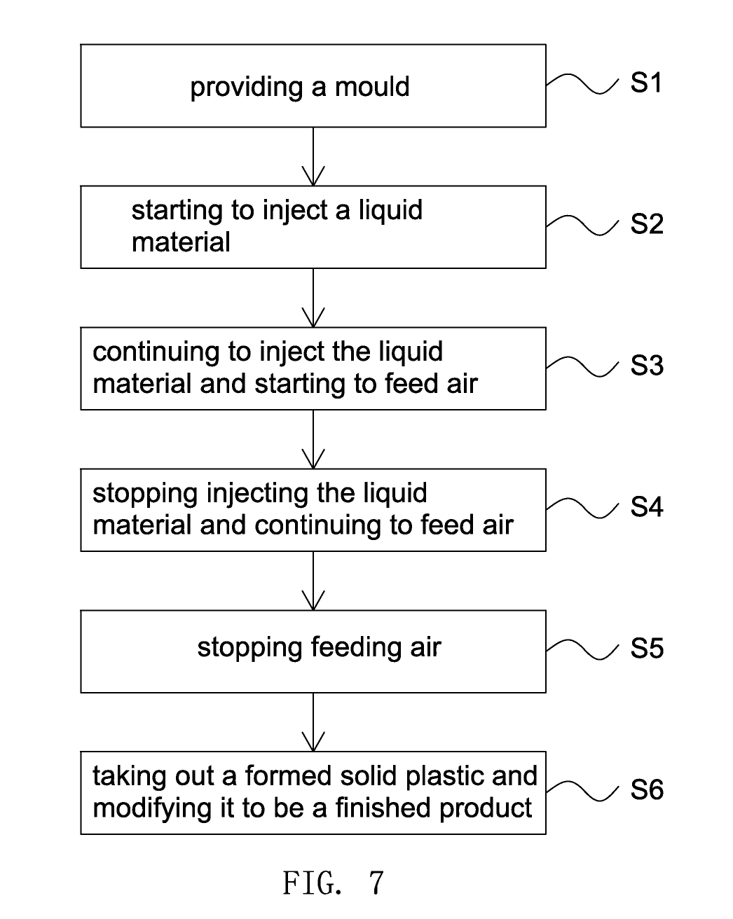

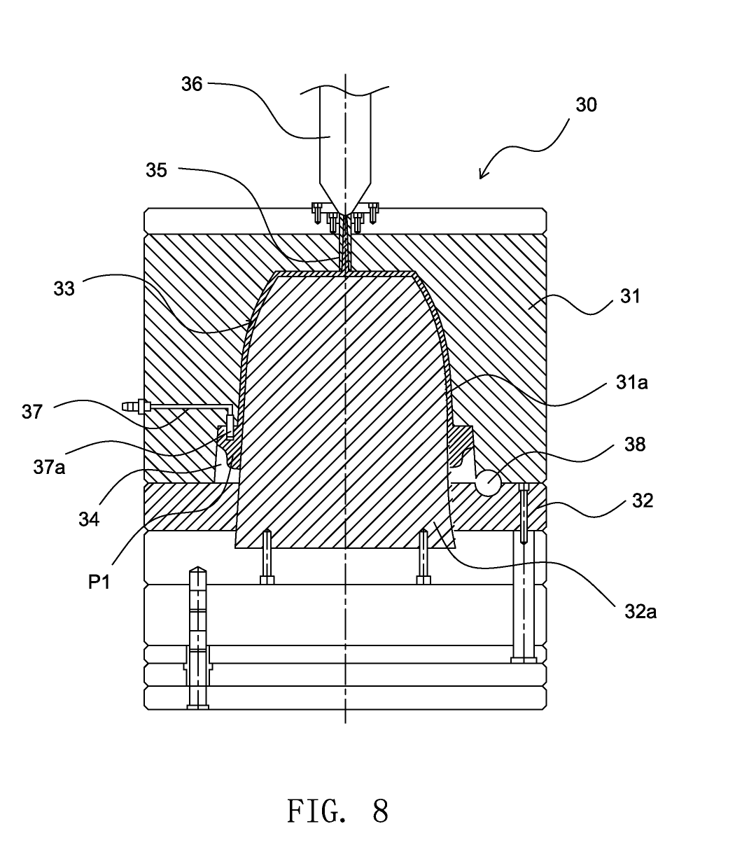

Please refer to FIG. 7, which disposes a flow chart of a method for manufacturing the plastic container having the flange according to one preferred embodiment of the present invention. And referring to FIGS. 8 to 12, which disclose schematic views of the method for manufacturing the plastic container having the flange according to one preferred embodiment of the present invention. The method for manufacturing the plastic container having the flange of the preferred embodiment of the present invention comprises the following steps:

First, a step S1 is providing a mould. Please refer to FIG. 6, the mould comprises a first mould plate having a mould cavity, a second mould plate having a mould insert that being combined with the mould cavity to form a body-forming space, a plastic-injecting pipe disposed on the first mould plate or the second mould plate and communicated with an exterior plastic-injecting system and the body-forming space, a flange-forming space surrounding an end surface of the body-forming space, an air-supplying pipe disposing an air-inputting opening on an edge of the flange-forming space and communicated with an exterior air-supplying system and the flange-forming space, and a material-overflowing space disposed on the edge of the flange-forming space, located on another side opposite to the air-supplying pipe, and connected to the flange-forming space through a small hole.

Next, a step S2 is starting to inject a liquid material. Please refer to FIG. 8, the liquid material P1 is injected into the body-forming space 33 and enters into the partial flange-forming space 34 by the plastic-injecting system 36.

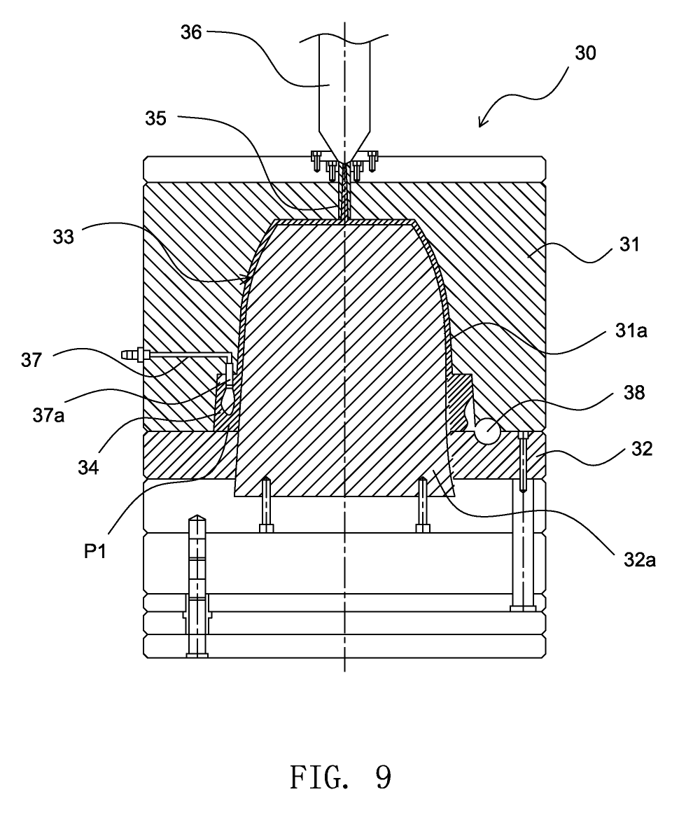

Next, a step S3 is continuing to inject the liquid material and starting to feed air. Please refer to FIG. 9, the liquid material P1 is continuously injected into the other portion of the flange-forming space 34, and the air-supplying system is used to feed air into the flange-forming space 34 through the air-supplying pipe 37 and the air-inputting opening 37a.

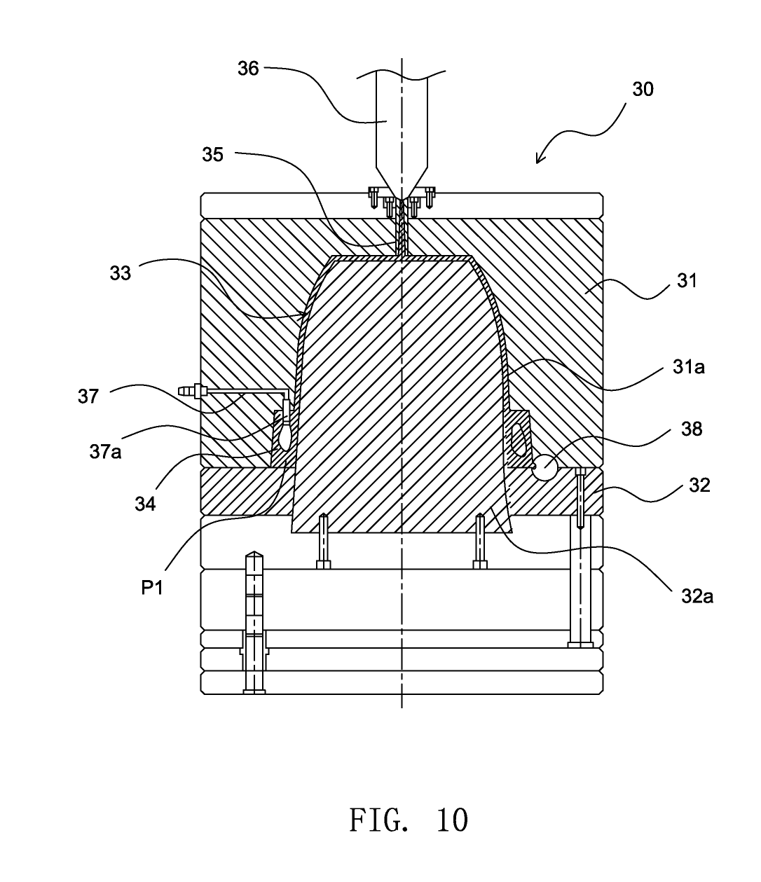

Next, a step S4 is stopping injecting the liquid material and continuing to feed air. Please refer to FIG. 10, the whole flange-forming space 34 has been fully filled with the liquid material P1, and the liquid material P1 is stopped being injected.

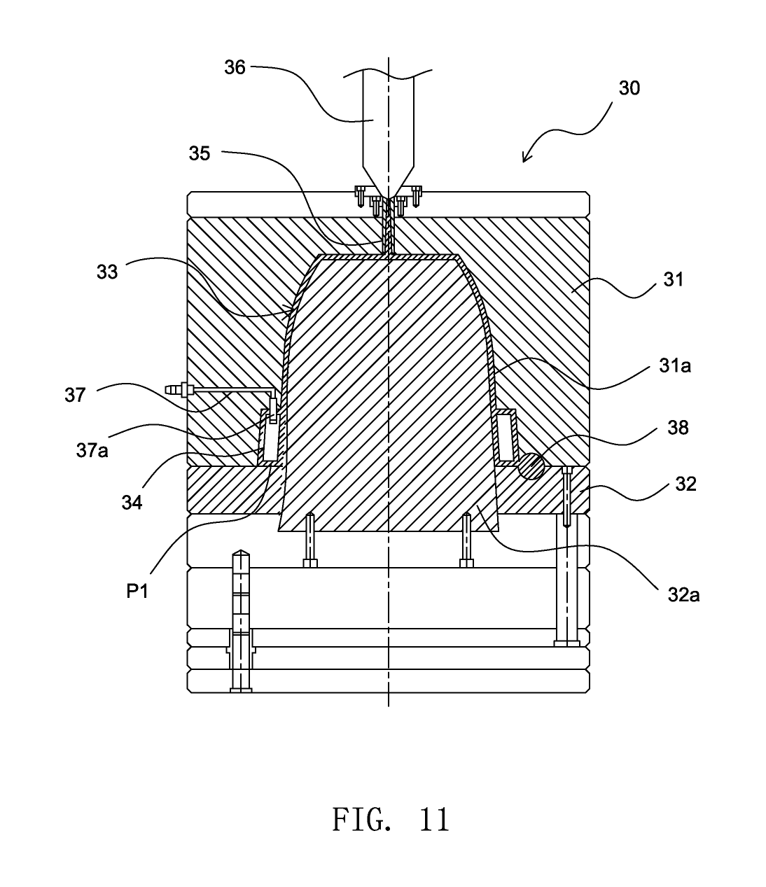

Next, a step S5 is stopping feeding air. Please refer to FIG. 11, the liquid material P1 is pushed toward inside walls of the flange-forming space 34 by the interior air of the flange-forming space 34 and is uniformly formed on the inside walls of the flange-forming space 34. The flange-forming space 34 forms a closed hollow shape (not labeled). Some unwanted liquid material P1 flows into the material-overflowing space 38 located on another side opposite to the air-supplying pipe 37.

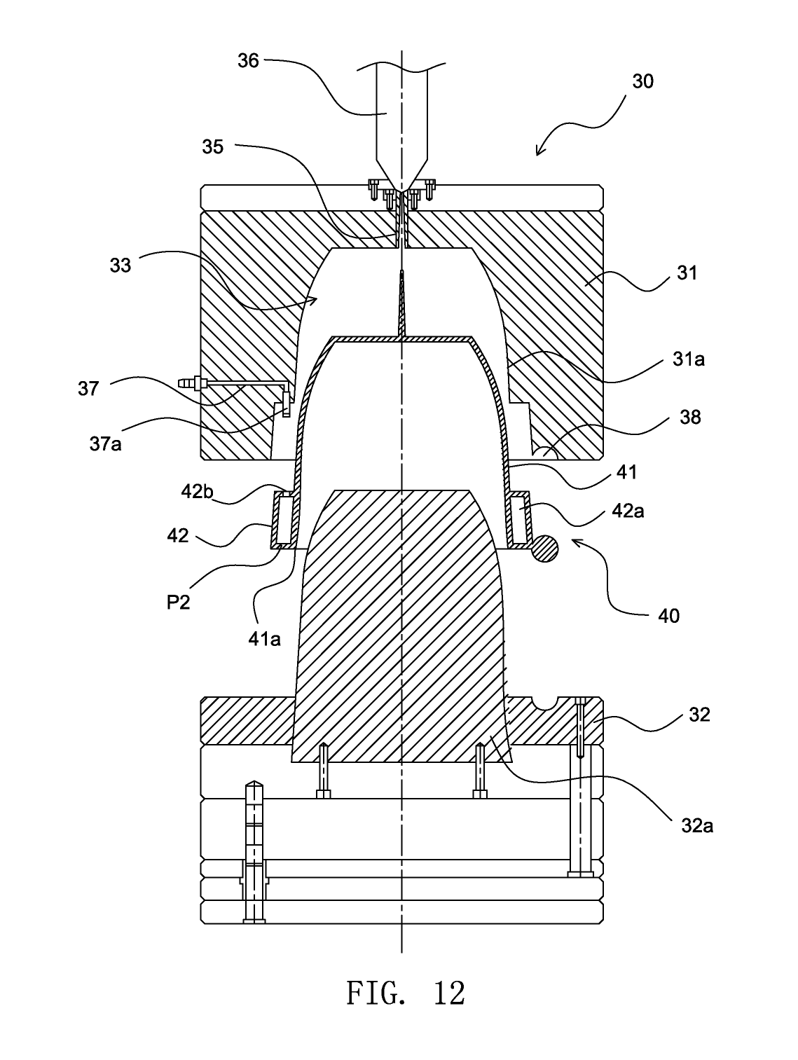

Finally, a step S6 is taking out a formed solid plastic and modifying it to be a finished product. Please again refer to FIG. 12, the liquid material P1 is cured to form a solid plastic P2 by packing pressure and cooling the mould. Now, the mould is opened for taking out the solid plastic P2, and the unwanted stub bars (not labeled) located on the bottom of the flowerpot and the unwanted material (not labeled) in the material-overflowing space 38 are removed, thereby obtaining the finished product 40 (such as the flowerpot) of the plastic container.

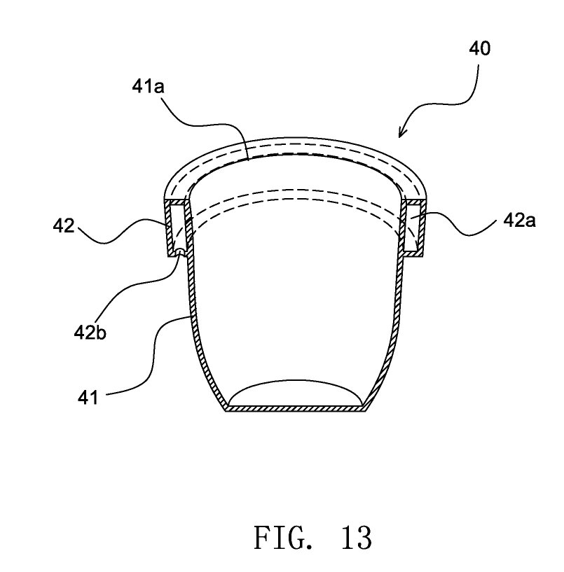

Please refer to FIG. 13, which discloses a perspective sectional view of a structure of the plastic container having the flange according to one preferred embodiment of the present invention. The method may manufacture the finished product 40. The finished product 40 (such as the flowerpot) of the plastic container having the flange comprises a body 41 and a flange 42. The body 41 is a container having an opening, which forms an upper edge 41a. The closed flange 42 is formed on the outside of the upper edge 41a, and has a closed hollow portion 42a. The body 41 and the flange 42 have an equivalent thickness.

Moreover, the plastic container 40 also comprises an aperture 42b remained by the air-inputting opening 37a of the mould 30. The aperture 42b may be used as a position connecting the hollow portion 42a of the flange to the environment, thereby venting the air fed by the plastic-injecting system 36 and also adjusting the inner air of the hollow portion 42a affected by heat expansion and cold contraction.

In conclusion, the air, which is fed into the flange-forming space 34 by the air-supplying system (not labeled) of the manufacturing method, is preferably inert gases, such as nitrogen gas. Furthermore, as shown in FIG. 8, a direction of the air entering into the flange-forming space 34 through the air-supplying pipe 37 is preferably the same with a direction of the liquid plastic P1 entering into the body-forming space 33 through the plastic-injecting pipe 35. Because the aperture 42b remained by the air-inputting opening 37a is located on a bottom edge of the flange 42, the appearance of the plastic container 40 may be not affected. The present invention does not limit the amount of the air-supplying pipe 37 and the air-inputting opening 37a. The user may determine the amount of the air-supplying pipe 37 and the air-inputting opening 37a by the actual demand. The flange 42 is preferably a round ring shape, but also may be other geometrical shapes being a closed ring shape. Moreover, the material-overflowing space 38 is preferably a spherical shape for efficiently accepting the overflowing material, but the present invention does not limit the location and the amount of the material-overflowing space 38.

Moreover, the present invention also does not limit the type of the plastic, which is adapted to the manufacturing method of the plastic forming. The plastic may be a plastic having a greater hardness, which is one of a high-density polyethylene (PE), a polypropylene (PP), an acrylonitrile butadiene styrene (ABS), a nylon and so on. The plastic may be a plastic having a small hardness, which is one of a low-density polyethylene (PE), a thermoplastic rubber (TPR), a polyvinylchlorid (PVC), a thermoplastic polyurethane pellet (TBU) and so on.

In addition, the time and the rate of starting and stopping feeding the air is relative to those of the plastic P1 entering into the flange-forming space and the flange-forming space being fully filled in the present invention. The user may control and adjust the time and the rate thereof by an outer control system according to the actual demand, thereby obtaining a most operation parameter, making the plastic P1 be uniformly formed on the inside walls of the flange-forming space 34 and making the flange-forming space 34 form a hollow shape.

Additionally, based on the need of making the mould or the functional consideration of the mould operation, the mould insert 32a and the second mould plate 32 may be an integral or separated design. In the preferred embodiment of the present invention, the mould insert 32a of the second mould plate 32 is additionally manufactured and then is locked in the second mould plate 32. In another embodiment (not drawn in all FIGS) of the present invention, the second mould plate 32 and the mould insert 32a are separated. An ejection mechanism (not drawn in all FIGS) is employed to detach the finished product 40 from the mould insert 32a by moving the second mould plate 32 a distance away from the first mould plate 31 after opening the mould, thereby separating the whole finished product 40 from the mould 30.

Comprising with the structure strength of the opened flange of the prior plastic container, after the prior container is loaded with the goods, if the opened flange is grasped to carry the container, the opened flange will be broken due to not taking the whole weight. In the present invention, the improvement structure of the mould 30 of the plastic container having the flange can feed the air into the flange-forming space 40 by the air-supplying pipe 37 and the material-overflowing space 38 disposed on an opposite direction during the injection molding of the mould, thereby obtaining the finished product 40 of the plastic container having a hollow-shaped flange 42. The flange 42 of the finished product 40 of the plastic container has the hollow portion 42a. The flange 42 and the body 41 have a uniform thickness and a better structure strength. When carrying the finished product 40 of the container, the flange 42 can bear the whole weight and not be broken.

The present invention has been disclosed by the preferred embodiment, but the preferred embodiment is not used to limit the scope of the present invention. Any person who skilled in the art may modify the embodiment of the present invention within the spirit and scope of the appended claims. Therefore, the protection scope of the present invention should take the appended claims as a criterion.

What is claimed is:

1. A mould of a plastic container having a flange, comprising:
a first mould plate having a mould cavity;
a second mould plate having a mould insert, the mould insert being combined with the mould cavity to form a body-forming space;
a plastic-injecting pipe disposed on the first mould plate or the second mould plate and communicated with an exterior plastic-injecting system and the body-forming space;
a flange-forming space surrounding an end surface of the body-forming space;
an air-supplying pipe disposing an air-inputting opening on an edge of the flange-forming space and communicated with an exterior air-supplying system and the flange-forming space; and
a material-overflowing space disposed on the edge of the flange-forming space, located on another side opposite to the air-supplying pipe, and connected to the flange-forming space through a small hole.

2. The mould of a plastic container having a flange as claimed in claim 1, wherein a direction of the air entering into the flange-forming space through the air-supplying pipe is the same with a direction of the liquid plastic entering into the body-forming space through the plastic-injecting pipe.

3. The mould of a plastic container having a flange as claimed in claim 1, wherein the material-overflowing space is a spherical shape.

4. The mould of a plastic container having a flange as claimed in claim 1, wherein the plastic container having the flange is a flowerpot.

5. The mould of a plastic container having a flange as claimed in claim 1, wherein the flange is a round ring shape.

6. The mould of a plastic container having a flange as claimed in claim 1, wherein the second mould plate and the mould insert are separated, and an ejection mechanism is employed to detach the finished product from the mould by moving the second mould plate a distance away from the first mould plate after opening the mould.

7. A structure of a plastic container having a flange, comprising: a body being a container having an opening, which forms an upper edge; and a flange forming on the outside of the upper edge and having a closed hollow portion.

8. The structure of the plastic container having the flange as claimed in claim 7, wherein the structure of the plastic container having the flange further comprises an aperture located on a bottom edge of the flange.

9. The structure of the plastic container having the flange as claimed in claim 7, wherein the body and the flange have an equivalent thickness.

10. A method for manufacturing a plastic container having a flange, comprising the following steps:
providing a mould, which including a first mould plate having a mould cavity, a second mould plate having a mould insert that being combined with the mould cavity to form a body-forming space, a plastic-injecting pipe disposed on the first mould plate or the second mould plate and communicated with an exterior plastic-injecting system and the body-forming space, a flange-forming space surrounding an end surface of the body-forming space, an air-supplying pipe disposing an air-inputting opening on an edge of the flange-forming space and communicated with an exterior air-supplying system and the flange-forming space, and a material-overflowing space disposed on the edge of the flange-forming space, located on another side opposite to the air-supplying pipe, and connected to the flange-forming space through a small hole;
starting to inject a liquid material, wherein the liquid material is injected into the body-forming space and enters into the partial flange-forming space;
continuing to inject the liquid material and starting to feed air, wherein the liquid material is continuously injected into other portions of the flange-forming space, and the air-supplying system is employed to feed the air into the flange-forming space through the air-supplying pipe and the air-inputting opening;
stopping injecting the liquid material and continuing to feed air, wherein the whole flange-forming space is fully filled with the liquid material, and the liquid material is stopped being injected;
stopping feeding air, wherein the liquid material is pushed toward inside walls of the flange-forming space by the interior air of the flange-forming space and is uniformly formed on the inside walls of the flange-forming space, the flange-forming space forms a closed hollow shape, and some unwanted liquid material flows into the material-overflowing space located on another side opposite to the air-supplying pipe; and
taking out a formed solid plastic and modifying it to be a finished product, wherein the liquid material is cured to form the solid plastic by packing pressure and cooling the mould, now the mould is opened for taking out the solid plastic, and unwanted stub bars located on a bottom of the plastic container and the unwanted material in the material-overflowing space are removed for obtaining the finished product of the plastic container.
